(19) United States
(12) Patent Application Publication
(10) Pub. No.: US 2010/0270273 A1
(43) Pub. Date: Oct. 28, 2010

(54) LASER BEAM PROCESSING MACHINE

(75) Inventor: Kazuma Sekiya, Ota-Ku (JP)

Correspondence Address: GREER, BURNS & CRAIN, 300 S WACKER DR, 25TH FLOOR, CHICAGO, IL, 60606, US

(73) Assignee: DISCO CORPORATION, Tokyo (JP)

(21) Appl. No.: 12/762,662

(22) Filed: Apr. 19, 2010

(30) Foreign Application Priority Data
Apr. 23, 2009 (JP) 2009-105132

(51) Int. Cl. B23K 26/00

(52) U.S. Cl. 219/121.6

(57) ABSTRACT

A laser beam processing machine that includes a laser beam irradiation unit for directing a laser beam to a workpiece held by a chuck table; a water-containing cover including an annular lateral wall surrounding the workpiece held by the chuck table, a top wall formed of a transparent member and closing an upper surface of the annular lateral wall, a water-supply hole and a water-discharge hole; a water-containing cover positioning unit for selectively positioning the water-containing cover at a waiting position remote from the chuck table and at an operating position where the water-containing cover surrounds the workpiece held by the chuck table; and a water supply unit connected to the water-supply hole.

### BACKGROUND OF THE INVENTION

1. Field of the Invention

The present invention relates to a laser beam processing machine which irradiates a predetermined area of a workpiece with a laser beam for predetermined processing.

2. Description of the Related Art

In the production process of a semiconductor device, a plurality of areas are sectioned by predetermined dividing lines called streets which are arranged in a lattice pattern on the front surface of a substantially disk-like semiconductor wafer, and a device such as IC or LSI is formed in each of the sectioned areas. Individual semiconductor devices are manufactured by cutting the semiconductor wafer along the streets to divide it into the areas in which the devices are formed. Also an optical device wafer in which a gallium nitride-based compound semiconductor or the like is laminated on the front surface of a sapphire substrate is cut and divided along streets into individual light-emitting diodes or laser diodes or the like, which are widely used in electric devices.

As the above-mentioned method of dividing the wafer such as a semiconductor wafer, an optical device wafer or the like along streets, the following method is proposed. A pulsed laser beam is directed to a wafer along streets formed thereon to form laser processing grooves and the wafer is fractured along the laser processing grooves. (See e.g. Japanese Patent Laid-open No. Hei 10-305420.) When the laser beam is directed to the wafer along the streets in this way, thermal energy concentrates on the irradiated area to produce debris thereat. This poses a problem in that such debris adhere to the front surface of the device, which degrades the quality of the device.

To prevent the influence of the debris due to the irradiation of the workpiece with a laser beam as described above, a laser processing method is proposed as below. Before laser beam irradiation, a front surface of a workpiece is coated with a protective film made of a liquid resin such as polyvinyl alcohol. A laser beam is directed to the workpiece through the protective film before the protective film coated on the front surface of the workpiece is removed. (See Japanese Patent Laid-open No. 2004-188475.) However, the laser processing method described in Japanese Patent Laid-open No. 2004-188475 needs a process of drying the protective film that has been coated on the front surface of the workpiece and also to remove the protective film coated on the front surface of the workpiece after the workpiece is irradiated with a laser beam through the protective film. Thus, there is a problem of low productivity. In addition, the liquid resin such as polyvinyl alcohol or the like used to form the protective film is relatively expensive and non-economical.

To solve the above-described problem, a laser processing method is disclosed in Japanese Patent Laid-open No. 2007-181856 as below. A water layer is formed on the front surface of a workpiece held by a chuck table. While spraying compressed air to an irradiation portion of a workpiece to be irradiated with a laser beam by a laser beam irradiation means to remove the water layer on the irradiation portion, the laser beam is emitted from the laser beam irradiation means to the workpiece for laser processing.

### SUMMARY OF THE INVENTION

However, since the chuck table holding the workpiece is shifted in a processing direction relative to the laser beam irradiation means, water moves and flows into the irradiation portion to which the compressed air is sprayed. Thus, it is difficult to reliably remove the water layer on the irradiation portion. If the laser beam is directed to the irradiation portion where water is left in fragments, the focal position of the laser beam varies due to a refractive index. Thus, there is a problem in that a laser beam cannot be directed to a predetermined position of the wafer.

Accordingly, it is an object of the present invention to provide a laser beam processing machine that can reliably direct a laser beam to a predetermined position of a workpiece and to prevent an influence of debris produced by the irradiation of the laser beam.

In accordance with an aspect of the present invention, there is provided a laser beam processing machine including: a chuck table for holding a workpiece; laser beam irradiation means for directing a laser beam to the workpiece held by the chuck table; a water-containing cover including an annular lateral wall surrounding the workpiece held by the chuck table, a top wall formed of a transparent member and closing an upper surface of the annular lateral wall, a water-supply hole and a water-discharge hole; cover-positioning means for selectively positioning the water-containing cover at a waiting position remote from the chuck table and at an operating position where the water-containing cover surrounds the workpiece held by the chuck table; and water-supply means connected to the water-supply hole, wherein the cover-positioning means is operated to position the water-containing cover at the operating position, and while the water-supply means is operated to fill the inside of the water-containing cover with water and discharge the water from the water-discharge hole, the laser beam irradiation means is operated to direct a laser beam to the workpiece through the top wall of the water-containing cover and through the water in the water-containing cover.

In accordance with the present invention, the cover-positioning means is operated to position the water-containing cover at the operating position and while the water-supply means is operated to fill the inside of the water-containing cover with water and discharge the water from the water-discharge hole, the laser beam irradiation means is operated to direct a laser beam to the workpiece through the top wall of the water-containing cover and through the water inside the water-containing cover. Therefore, since the water front surface is stable without variation even if the chuck table is shifted, the focal point of the laser beam is not varied. In addition, thermal energy concentrates on an area irradiated with a laser beam to produce debris, which scatter. However, since the debris thus scattered are suspended in the water and discharged through the water-discharge hole, they will not adhere to the front surface of the workpiece.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a laser beam processing machine configured according to the present invention;

FIG. 2 is a cross-sectional view of a chuck table installed in the laser beam processing machine illustrated in FIG. 1;

FIG. 3 is a cross-sectional view of a water-containing cover constituting part of a water-containing cover mechanism installed in the laser beam processing machine illustrated in FIG. 1;

FIG. 4 is a perspective view illustrated in a state where a semiconductor wafer as a workpiece is stuck to an adhesive tape attached to an annular frame;

FIG. 5 is a cross-sectional view illustrating a state where the semiconductor wafer as a workpiece held by the chuck table is surrounded and positioned by the water-containing cover constituting part of the water-containing cover mechanism illustrated in FIG. 3;

FIG. 6 is an explanatory view of a laser beam irradiation process executed by the laser beam processing machine illustrated in FIG. 1;

FIG. 7 is an explanatory view illustrating a focal point of the laser beam emitted in the laser beam irradiation process illustrated in FIG. 6; and

FIG. 8 is an explanatory enlarged cross-sectional view of the main part of the semiconductor wafer as a workpiece executed in the laser beam irradiation process illustrated in FIG. 6.

### DETAILED DESCRIPTION OF THE PREFERRED EMBODIMENTS

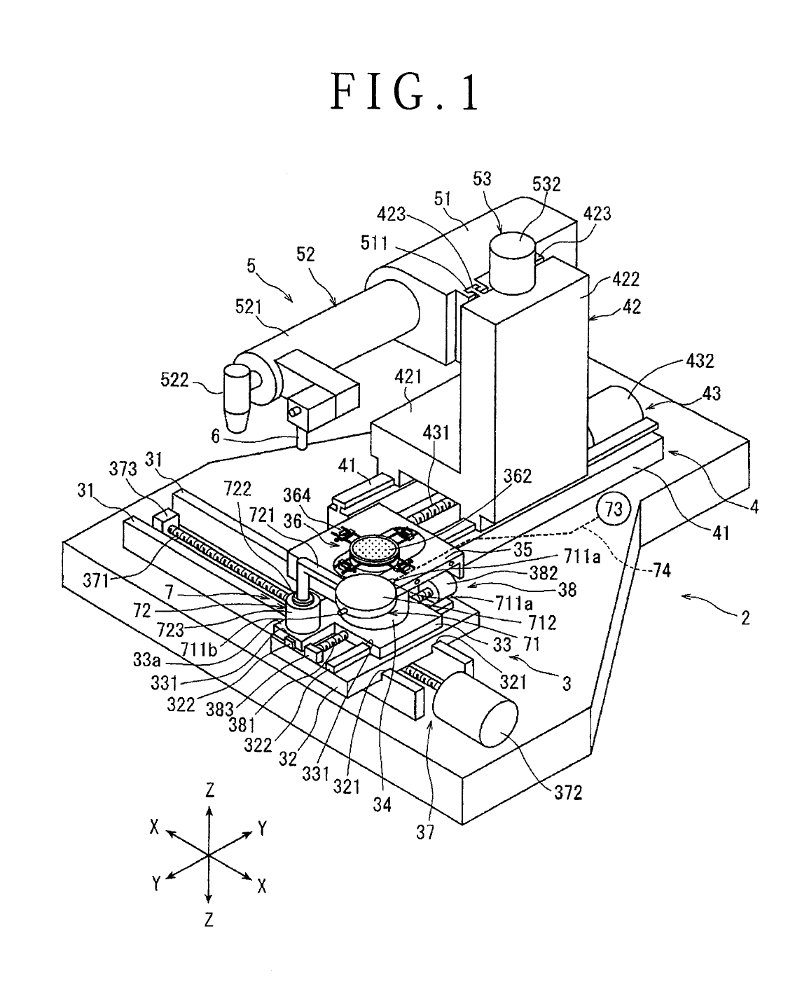

Preferred embodiments of a laser beam processing machine configured according to the present invention will hereinafter be described with reference to the accompanying drawings. FIG. 1 is a perspective view of a laser beam processing machine configured according to the present invention. A laser beam processing machine illustrated in FIG. 1 includes a stationary base 2 and a chuck table mechanism 3 mounted on the stationary base 2 so as to be shiftable in a processing-transfer direction (X-axial direction) indicated with arrow X and to hold a workpiece. The laser beam processing machine further includes a laser beam irradiation unit support mechanism 4 mounted on the stationary base 2 so as to be shiftable in an indexing-transfer direction (Y-axial direction), indicated with arrow Y, perpendicular to the direction (X-axial direction) indicated with arrow X; and a laser beam irradiation unit 5 mounted on the laser beam irratiation unit support mechanism 4 so as to be shiftable in a focal-position adjusting direction (Z-axial direction) indicated with arrow Z.

The chuck table mechanism 3 includes a pair of guide rails 31, 31 mounted on the stationary base 2 in parallel to the processing-transfer direction indicated with arrow X and a first slide block 32 mounted on the guide rails 31, 31 so as to be shiftable in the X-axial direction. The chuck table mechanism 3 further includes a second slide block 33 mounted on the first slide block 32 so as to be shiftable in the Y-axial direction, a cover table 35 supported by a support tubular body 34 mounted on the second slide block 33, and a chuck table 36 as a workpiece-holding means.

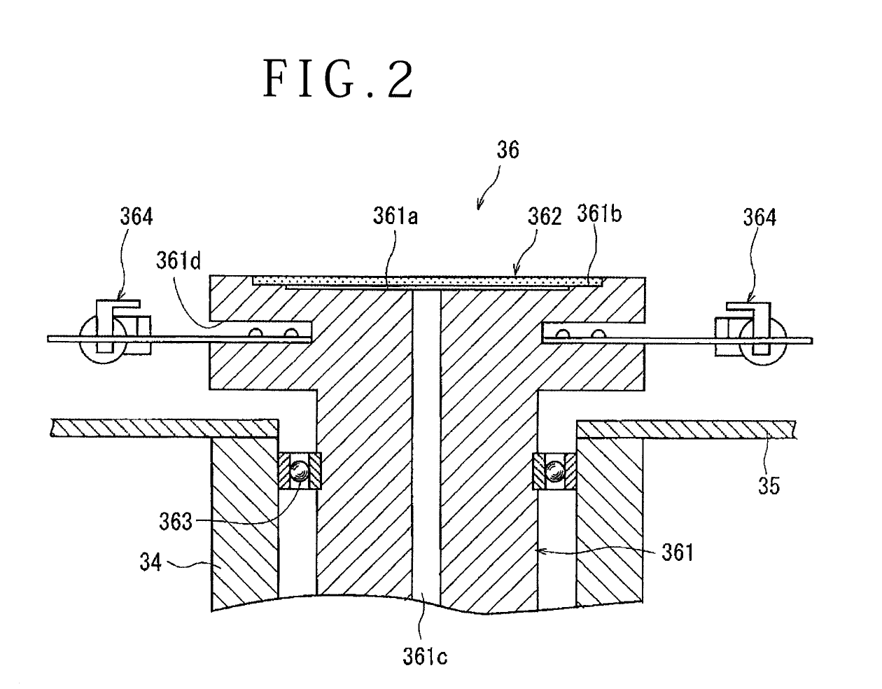

The chuck table 36 is described with reference to FIG. 2. The chuck table 36 illustrated in FIG. 2 includes a columnar main body 361 and a suction chuck 362 formed of perforated porous ceramic and disposed on the upper surface of the main body 361. The main body 361 is formed of a metal material such as stainless steel or the like and provided with a circular fitting recessed portion 361a on its upper surface. The fitting recessed portion 361a is provided on the outer circumferential portion of a bottom surface with an annular shelf 361b on which the suction chuck 362 is placed. The main body 361 is provided with a suction passage 361c communicating with the fitting recessed portion 361a. The suction passage 361c communicates with a suction means not illustrated. In this way, if the suction means not illustrated is operated, negative pressure is applied to the fitting recessed portion 361a through the suction passage 361c. This negative pressure is applied to the front surface of the suction chuck 362 formed of porous ceramics to suck and hold a workpiece placed on the suction chuck 362.

The chuck table 36 configured as above is such that the main body 361 is rotatably supported via bearings 363 by the cylindrical support tubular body 34 mounted on the upper surface of the second slide block 33 and appropriately rotated by a rotation drive means not illustrated. The cover table 35 is mounted on the upper end of the support tubular body 34. An annular groove 361d is formed in an upper portion of the main body 361 constituting part of the chuck table 36. Respective bases of four clamps 364 are arranged in the annular groove 361d and secured to the main body 361 by appropriate securing means.

The first slide block 32 is provided on the lower surface with a pair of guided grooves 321, 321 fitted to the pair of respective guide rails 31, 31 and on the upper surface with a pair of guide rails 322, 322 formed parallel to the Y-axial direction. The first slide block 32 configured as above can be moved in the X-axial direction along the pair of guide rails 31, 31 because of the guided grooves 321, 321 being fitted to the pair of respective guide rails 31, 31. The chuck table mechanism 3 in the illustrated embodiment is provided with a processing-transfer means 37 for shifting the first slide block 32 in the X-axial direction along the pair of guide rails 31, 31.

The processing-transfer means 37 includes an external screw rod 371 disposed between and parallel to the pair of guide rails 31, 31, and a drive source such as a pulse motor 372 for turnably driving the external screw rod 371. The external screw rod 371 has one end turnably supported by a bearing block 373 secured to the stationary base 2 and the other end transmittably connected to the output shaft of the pulse motor 372. Incidentally, the external screw rod 371 is threadedly engaged with a passing-through internal screw hole formed in an internal screw block, not illustrated, provided to project from the lower surface of a central portion of the first slide block 32. In this way, the first slide block 32 is shifted in the X-axial direction along the guide rails 31, 31 by allowing the pulse motor 372 to drive the external screw rod 371 for normal and reverse rotation.

The second slide block 33 is formed on one side in the X-axial direction with a protruding portion 33a protruding toward the front side. This protruding portion 33a functions as a table on which a water-containing cover mechanism described later is mounted. The second slide block 33 formed as above is provided on a lower surface with a pair of guided grooves 331, 331 fitted to the pair of respective guide rails 322, 322 mounted on the upper surface of the first slide block 32. In this way, since the guided grooves 331, 331 are fitted to the pair of respective guide rails 322, 322, the second slide block 33 can be shifted in the Y-axial direction. The chuck table mechanism 3 in the illustrated embodiment includes a first indexing-transfer means 38 for shifting the second slide block 33 in the Y-axial direction along the pair of guide rails 322, 322 mounted on the first slide block 32.

The first indexing-transfer means 38 includes an external screw rod 381 disposed between and parallel to the pair of guide rails 322, 322, and a drive source such as a pulse motor 382 or the like for turnably driving the external screw rod 381. The external screw rod 381 has one end rotatably supported by a bearing block 383 secured to an upper surface of the first slide block 32 and the other end transmittably connected to the output shaft of the pulse motor 382. Incidentally, the external screw rod 381 is threadedly engaged with a passing-through internal screw hole formed in an internal screw block, not illustrated, provided on a lower surface of a central portion of the second slide block 33 to project therefrom. In this way, the second slide block 33 is shifted in the Y-axial direction along the guide rails 322, 322 by allowing the pulse motor 382 to drive the external screw rod 381 for normal and reverse rotation.

The laser beam irradiation unit support mechanism 4 includes a pair of guide rails 41, 41 mounted on the stationary base 2 so as to extend parallel to the Y-axial direction, and a movable support base 42 mounted on the guide rails 41, 41 so as to be shiftable in the direction indicated with arrow Y. The movable support base 42 includes a shifting support portion 421 shiftably mounted on the guide rails 41, 41, and an attachment portion 422 mounted to the shifting support portion 421. The attachment portion 422 is provided on one lateral surface with a pair of guide rails 423, 423 parallel extending in the Z-axial direction. The laser beam irradiation unit support mechanism 4 in the illustrated embodiment includes a second indexing-transfer means 43 for shifting the movable support base 42 in the Y-axial direction along the pair of guide rails 41, 41.

The second indexing-transfer means 43 includes an external screw rod 431 disposed between and parallel to the pair of guide rails 41, 41 and a drive source such as a pulse motor 432 or the like for turnably driving the external screw rod 431. The external screw rod 431 has one end rotatably supported by a bearing block, not illustrated, secured to the stationary base 2 and the other end transmittably connected to the output shaft of the pulse motor 432. Incidentally, the external screw rod 431 is threadedly engaged with an internal screw hole formed in an internal screw block, not illustrated, provided to project from a lower surface of a central portion of the shifting support portion 421 constituting part of the movable support base 42. In this way, the movable support base 42 is shifted in the Y-axial direction along the guide rails 41, 41 by allowing the pulse motor 432 to drive the external screw rod 431 for normal and reverse rotation.

The laser beam irradiation unit 5 includes a unit holder 51 and a laser beam irradiation means 52 mounted to the unit holder 51. The unit holder 51 is provided with a pair of guided grooves 511, 511 slidably fitted to the pair of respective guide rails 423, 423 provided on the attachment portion 422. The guided grooves 511, 511 are fitted to the respective guide rails 423, 423 so that the unit holder 51 is supported shiftably in a focal position adjusting direction (Z-axial direction) indicated with arrow Z.

The laser beam irradiation unit 5 is provided with a first focal position adjusting means 53 for shifting the unit holder 51 along the pair of guide rails 423, 423 in the Z-axial direction which is a direction perpendicular to a workpiece-holding surface of the chuck table 36. The first focal position adjusting means 53 includes an external screw rod (not illustrated) disposed between the pair of guide rails 423, 423, and a drive source such as a pulse motor 532 or the like for turnably driving the external screw rod. The unit holder 51 and the laser beam irradiation means 52 are shifted in the Z-axial direction along the guide rails 423, 423 by allowing the pulse motor 532 to drive the external screw rod, not illustrated, for normal and reverse rotation. Incidentally, in the illustrated embodiment, the pulse motor 532 is driven for normal rotation to shift the laser beam irradiation means 52 upward and driven for reverse rotation to shift it downward.

The laser beam irradiation means 52 emits a pulsed laser beam from an optical concentrator 522 attached to the distal end of a cylindrical casing 521 disposed to extend substantially horizontally. An imaging means 6 is disposed at a front end portion of the casing 521 constituting part of the laser beam irradiation means 52. This imaging means 6 detects a processing area to be laser processed by the laser beam irradiation means 52. The imaging means 6 includes an illuminating means for illuminating the workpiece, an optical system for capturing an area illuminated by the illuminating means, and an image pickup element (CCD) picking up an image captured by the optical system. The imaging means sends data of the picked-up image to a control means not illustrated.

The laser beam processing machine in the illustrated embodiment includes a water-containing cover mechanism 7 disposed on the protruding portion 33a of the second slide block 33 so as to selectively surround the workpiece held by the chuck table 36. The water-containing cover mechanism 7 includes a water-containing cover 71, a water-containing cover positioning means 72 and a water-supply means 73. The water-containing cover 71 surrounds the workpiece held by the chuck table 36. The water-containing cover positioning means 72 selectively positions the water-containing cover 71 at a waiting position remote from the chuck table 36 illustrated in FIG. 1 and an operating position where the workpiece held by the chuck table 36 is surrounded by the water-containing cover 71. The water-supply means 73 supplies water into the water-containing cover 71.

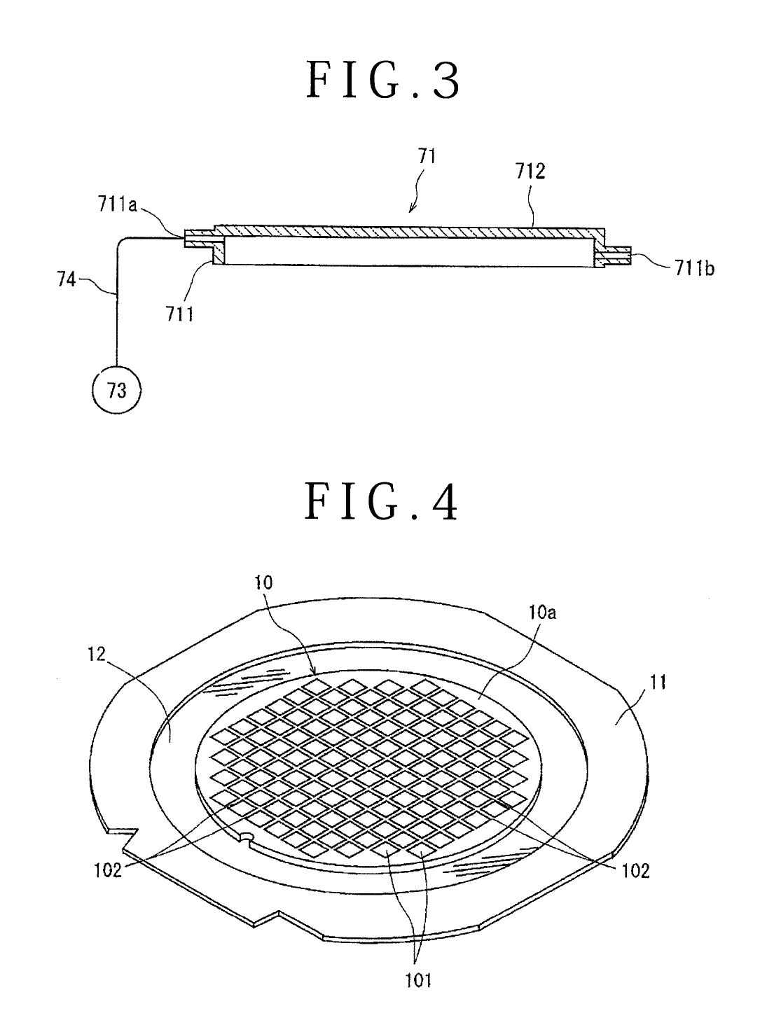

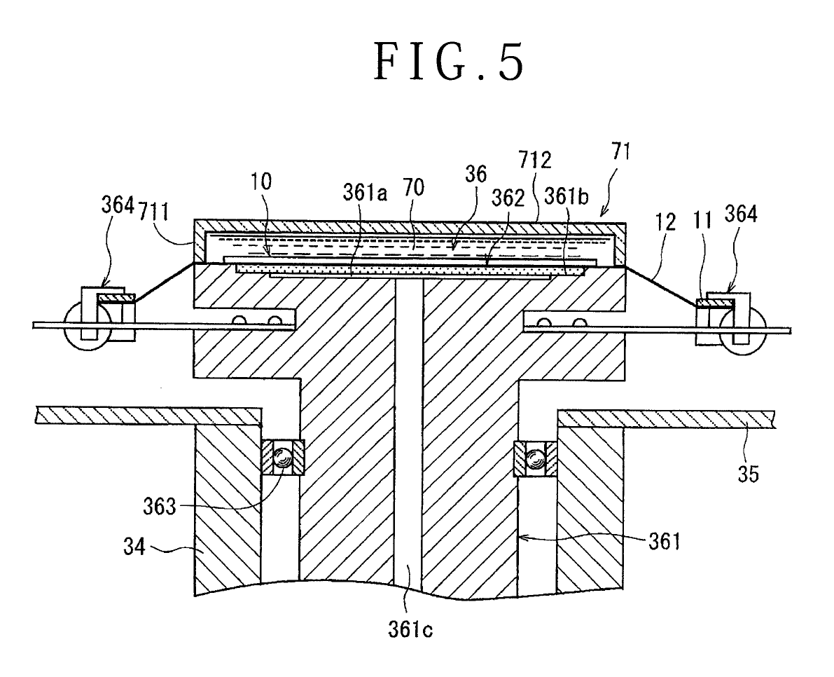

The water-containing cover 71 constituting part of the water-containing cover mechanism 7 is described with reference to FIG. 3. The water-containing cover 71 illustrated in FIG. 3 includes an annular lateral wall 711 surrounding a semiconductor wafer as a workpiece, described later, held by the chuck table 36, and a top wall 712 closing the upper surface of the annular lateral wall 711. In addition, the water-containing cover 71 is formed like a reversed cup. Further, the water-containing cover 71 is integrally formed of transparent glass or a synthetic resin in the illustrated embodiment. Incidentally, the water-containing cover 71 is needed so that only the top wall 712 is formed of a transparent member. The water-containing cover 71 formed as described above is provided with a water-supply hole 711a in the upper portion of the annular lateral wall 711 and with a water-discharge hole 711b in the lower portion of the annular lateral wall 711. The water-supply hole 711a is connected to the water-supply means 73 via a flexible hose 74.

The explanation is continued returning to FIG. 1. The water-containing cover positioning means 72 constituting part of the water-containing cover mechanism 7 includes a support arm 721 supporting the water-containing cover 71, an air cylinder 722 supporting the proximal end of the support arm 721 so as to be shiftable in an up-down direction, and an electric motor 723 turnably supporting the air cylinder 722. The electric motor 723 is disposed on the upper surface of the protruding portion 33a of the second slide block 33. The water-containing cover positioning means 72 configured as described above operates the air cylinder 722 and the electric motor 723 to shift the support arm 721 in the up-down direction and to turn it around the proximal end of the support arm 721. In this way, the water-containing cover positioning means 72 selectively positions the water-containing cover 71 at the waiting position or standby position illustrated in FIG. 1 and the operating position where the workpiece held by the chuck table 36 is surrounded by the water-containing cover 71.

The laser beam processing machine in the illustrated embodiment is configured as described above and its operation is described below. A semiconductor wafer as a workpiece subjected to laser processing by the laser beam processing machine described above is here described with reference to FIG. 4. A semiconductor wafer 10 illustrated in FIG. 4 is a silicon wafer and a plurality of devices 101 are formed on a front surface 10a of the semiconductor wafer 10 in a matrix pattern. The devices 101 are sectioned by streets 102 formed in a lattice-like pattern. A rear surface of the semiconductor wafer 10 is stuck to an adhesive tape 12 attached to an annular frame 11 with the front surface 10a, a processing surface, facing the upside. Incidentally, if the semiconductor wafer 10 is processed from the rear surface, the front surface 10a of the semiconductor wafer 10 is stuck to the adhesive tape 12. The adhesive tape 12 uses e.g. tape in which an acrylic resin adhesive is applied, to a thickness of approximately 5 μm, to the front surface of a synthetic resin sheet such as polyolefin, polyethylene or the like having a thickness of e.g. 100 μm.

In order to form laser processing grooves along the streets 102 by directing a laser beam along the streets 102 of the semiconductor wafer 10 described above, the semiconductor wafer 10 stuck to the front surface of the adhesive tape 12 attached to the annular frame 11 is placed on the suction chuck 362 of the chuck table 36 via the adhesive tape 12. After the semiconductor wafer 10 is placed on the chuck table 36 via the adhesive tape 12, a suction means not illustrated is operated to apply negative pressure to the front surface of the suction chuck 362 via the suction passage 361c and the fitting recessed portion 361a. In this way, the semiconductor wafer 10 is sucked and held on the chuck table 36 via the adhesive tape 12. The annular frame 11 supporting the semiconductor wafer 10 via the adhesive tape 12 is secured by the clamps 364.

The chuck table 36 sucking and holding the semiconductor wafer 10 is positioned immediately below the imaging means 6 by the processing-transfer means 37. After the chuck table 36 is positioned immediately below the imaging means 6, alignment work is carried out in which a process area of the semiconductor wafer 10 to be laser processed is detected by the imaging means 6 and control means not illustrated. Specifically, the imaging means 6 and the control means not illustrated execute image processing such as pattern matching or the like and the alignment of laser beam irradiation positions. The pattern matching is executed for positioning between streets 102 formed to extend in a predetermined direction of the semiconductor wafer 10 and a concentrator 522 of the laser beam irradiation means 52 for emitting a laser beam along the streets 102. Similarly, alignment of a laser beam irradiation position is executed on streets 102 formed on the semiconductor wafer 10 so as to extend in a direction perpendicular to the above-mentioned predetermined direction.

After the alignment work of the laser beam irradiation position is executed, the electric motor 723 of the water-containing cover positioning means 72 constituting part of the water-containing cover mechanism 7 is operated to turn the support arm 721 to shift the water-containing cover 71 to above the chuck table 36. The air cylinder 722 is operated to lower the water-containing cover 71 so that a lower edge of the annular lateral wall 711 of the water-containing cover 71 is placed on the upper surface of the adhesive tape 12 on the chuck table 36 so as to surround the semiconductor wafer 10. Thus, the semiconductor wafer 10 is surrounded by the water-containing cover 71. Next, the water-supply means 73 constituting part of the water-containing cover mechanism 7 is operated to supply pure water into the water-containing cover 71 via the flexible hose 74 and the water-supply hole 711a (see FIGS. 1 and 4) to fill the inside of the water-containing cover 71 with the pure water 70. In this way, a laser beam irradiation process described below is executed while supplying the pure water 70 into the water-containing cover 71 and discharging it from the water-discharge hole 711b. Incidentally, the alignment work for the laser beam irradiation position may be executed after the semiconductor wafer 10 is surrounded by the water-containing cover 71 and the pure water 70 is supplied into the water-containing cover 71.

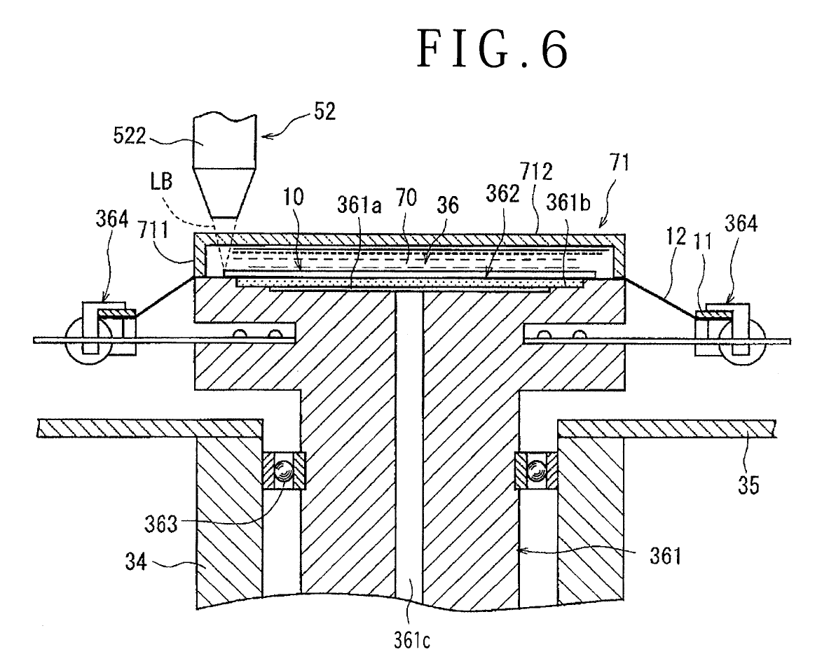

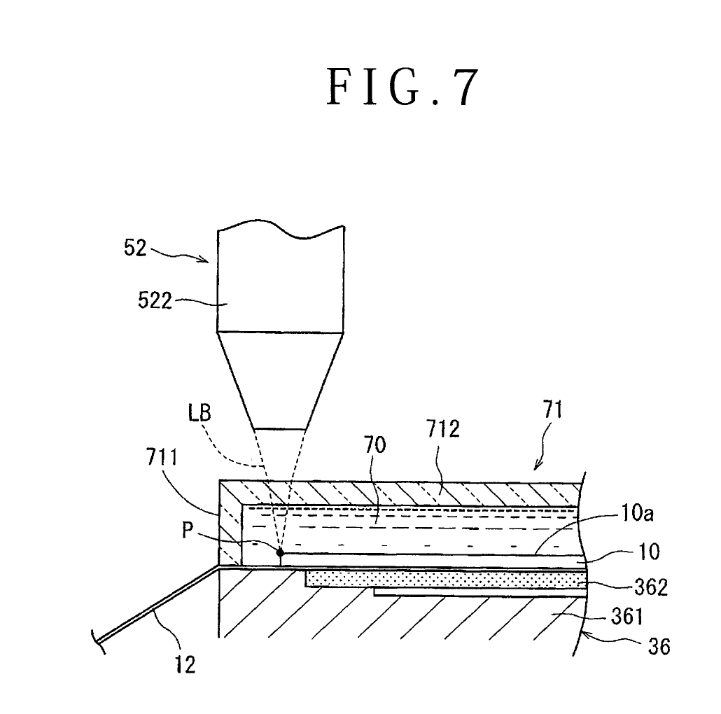

In order to execute the laser beam irradiation process, the chuck table 36 is shifted to position one end (a left end in FIG. 6) of a predetermined street 102 as illustrated in FIG. 6 at a position immediately below the concentrator 522. The chuck table 36 is shifted in a direction indicated with arrow X1 in FIG. 6 at a predetermined processing-transfer rate while the laser beam irradiation means 52 is operated to allow the concentrator 522 to emit a pulsed laser beam LB having a wavelength of e.g. 355 nm capable of being absorbed by the silicon wafer. If the irradiation position of the concentrator 522 comes to coincide with the position of the other end of the street 102, the irradiation of the pulsed laser beam is stopped and the shifting of the chuck table 36 is stopped. In the laser beam irradiation process, the pulsed laser beam LB emitted from the concentrator 522 passes through the top wall 712, made of a transparent member, of the water-containing cover 71 and the pure water 70 and is positioned at a focal point P close to the front surface 10a (the upper surface) of the semiconductor wafer 10 held by the chuck table 36 as shown in FIG. 7.

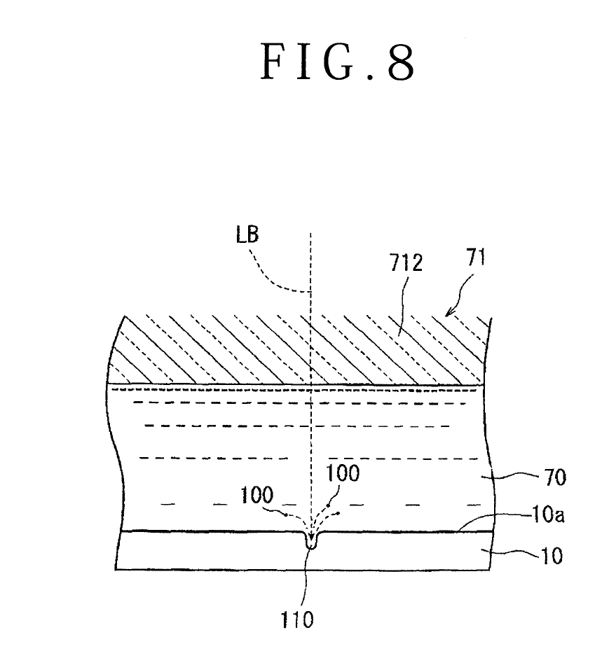

In this case, since the water-containing cover 71 is internally filled with the pure water 70, the front surface of the pure water 70 is stable without variation even if the chuck table 36 is shifted. Thus, the focal point P of the pulsed laser beam LB is not varied. The semiconductor wafer 10 is formed with a laser processing groove 110 along the street 102 as illustrated in FIG. 8 by executing the laser beam irradiation process as described above. In the laser beam irradiation process, thermal energy concentrates on an area irradiated with the pulsed laser beam in the front surface 10a of the semiconductor wafer 10 to produce debris 100 thereat, which scatter. However, the scattering debris 100 are suspended in the pure water 70 and discharged through the water-discharge hole 711b. Therefore, the debris 100 will not adhere to the front surface 10a of the semiconductor wafer 10.

Incidentally, processing conditions of the laser beam irradiation process described above are set as below in the illustrated embodiment.

| | |
|---|---|
| Light source: | LD excitation Q switch Nd: |
| | YVO4 pulsed laser |
| Wavelength: | 355 nm |
| Average output: | 5 W |
| Focal spot diameter: | φ10 μm |
| Cyclic frequency: | 100 kHz |
| Processing-transfer rate: | 100 mm/sec |

The laser beam irradiation process is executed along the predetermined streets formed on the semiconductor wafer 10 as described above. Thereafter, the chuck table 36 is indexing-transferred at an interval of the streets 102 in an indexing-transfer direction (the Y-axial direction) indicated with arrow Y in FIG. 1 (the indexing process) and the laser beam irradiation process mentioned above is executed. The laser beam irradiation process and the indexing process are executed on all the streets 102 extending in the first direction of the semiconductor wafer 10 as described above. Then, the supply of pure water by the water-supply means 73 constituting part of the water-containing cover mechanism 7 is topped and the air cylinder 722 is operated to raise the water-containing cover 71. Thereafter, the chuck table 36 is turned by 90 degrees to turn the semiconductor wafer 10 held by the chuck table 36 by 90 degrees. The air cylinder 722 is operated to lower the water-containing cover 71 so that the lower edge of the annular lateral wall 711 of the water-containing cover 71 is placed again on the upper surface of the adhesive tape 12 on the chuck table 36 to surround the semiconductor wafer 10. The water-containing cover 71 is surrounded by the semiconductor wafer 10 in this way. Next, while the water-supply means 73 constituting part of the water-containing cover mechanism 7 is operated to supply pure water into the water-containing cover 71, the laser beam irradiation process and the indexing process described above are executed on the streets 102 extending in the second direction perpendicular to the first direction. Thus, the laser processing grooves 110 are formed along all the streets 102 of the semiconductor wafer 10. Incidentally, in the laser beam irradiation process, the semiconductor wafer 10 may fully be cut through the laser processing grooves along the streets 102.

After the laser processing grooves 110 are formed along all the streets 102 of the semiconductor wafer 10, the operation of the water-supply means 73 of the water-containing cover mechanism 7 is stopped. Consequently, the pure water 70 in the water-containing cover 71 is discharged through the water-discharge hole 711b. Next, the chuck table 36 is returned to a workpiece carry-in/out position shown in FIG. 1. The air cylinder 722 and the electric motor 723 constituting part of the water-containing cover positioning means 72 of the water-containing cover mechanism 7 are operated to return the water-containing cover 71 to the waiting position shown in FIG. 1. Next, the suction means not illustrated is stopped to release the suction-holding of the semiconductor wafer 10 held by the chuck table 36. The fixation of the annular frame 11 by means of the clamps 364 is released. Next, if the semiconductor wafer 10 is not fully cut along the streets 102, the semiconductor wafer 10 being held by the annular frame 11 via the adhesive tape 12 is conveyed to the next process, a division process. In the division process, the semiconductor wafer 10 is divided into individual devices by applying an external force to the semiconductor wafer 10 along the laser processing grooves 110 formed thereon.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser beam processing machine comprising:
a chuck table for holding a workpiece;
laser beam irradiation means for directing a laser beam to the workpiece held by the chuck table;
a water-containing cover including an annular lateral wall surrounding the workpiece held by the chuck table, a top wall formed of a transparent member and closing an upper surface of the annular lateral wall, a water-supply hole and a water-discharge hole;
cover-positioning means for selectively positioning the water-containing cover at a waiting position remote from the chuck table and at an operating position where the water-containing cover surrounds the workpiece held by the chuck table; and
water-supply means connected to the water-supply hole,
wherein the cover-positioning means is operated to position the water-containing cover at the operating position, and while the water-supply means is operated to fill the inside of the water-containing cover with water and discharge the water from the water-discharge hole, the laser beam irradiation means is operated to direct a laser beam to the workpiece through the top wall of the water-containing cover and through the water in the water-containing cover.
